(19) United States
(12) Patent Application Publication
(10) Pub. No.: US 2018/0308070 A1
(43) Pub. Date: Oct. 25, 2018

(54) Systems and Methods for Use in Providing Transaction Settlement Services

(71) Applicant: MASTERCARD INTERNATIONAL INCORPORATED, Purchase, NY (US)

(72) Inventor: Rasika Raina, Bedford Hills, NY (US)

(21) Appl. No.: 15/958,247

(22) Filed: Apr. 20, 2018

Related U.S. Application Data
(60) Provisional application No. 62/488,277, filed on Apr. 21, 2017.

(51) Int. Cl. G06Q 20/02; G06F 17/30

(52) U.S. Cl. CPC G06Q 20/027; G06F 17/30569

(57) ABSTRACT

Systems and methods are provided for providing settlement services for transactions. One exemplary system includes a settlement computing device, which is configured to receive a first message from an origination computing device, where the first message defines a network transaction between a first party and a second party and is in a first standard format and includes data in multiple data fields, and where the first standard format is associated with the origination computing device. The settlement computing device is further configured to convert the message from the first standard format to a second message in a second standard format different than the first standard format, whereby the second message includes at least a portion of the data included in the message, and direct settlement of the network transaction based on the second message, whereby the origination computing device provides settlement through the settlement computing device.

### CROSS-REFERENCE TO RELATED APPLICATION

This application claims the benefit of, and priority to, U.S. Provisional Application No. 62/488,277 filed on Apr. 21, 2017. The entire disclosure of the above referenced application is incorporated herein by reference.

### FIELD

The present disclosure generally relates to systems and methods for use in providing settlement services, and in particular, for use in providing settlement of network transactions, by settlement computing device, on behalf of origination computing devices through which the network transactions were initiated.

### BACKGROUND

This section provides background information related to the present disclosure which is not necessarily prior art.

Fund transfers are known to occur between accounts at different transacting institutions. The fund transfers may be pursuant to consumer transactions (e.g., credit card transactions, etc.), etc. In general, each of the transfers includes two parts: authorization and settlement. The authorization includes authorization of the transaction, either as a request to charge or as a request for refund, while settlement includes the transfer of funds between the involved accounts consistent with the charge or refund. Settlement is often the product of dozens, hundreds, or thousands of transactions between two transacting entities, where the actual transferred funds are equal to the total of the transactions between the two transacting entities. Conventionally, for certain transactions, the authorization and settlement of the transactions are coordinated through the same payment network.

Alternatively, a payment network may be limited to the origination of the transactions, through use of messaging between transacting institutions. The settlement part, then, is coordinated directly between the transacting institutions (or affiliates in the appropriate regions, as needed) involved in the transactions. One example of such an “origination” payment network is the SWIFT™ payment network (see, https://www.swift.com/).

### DRAWINGS

The drawings described herein are for illustrative purposes only of selected embodiments and not all possible implementations, and are not intended to limit the scope of the present disclosure.

FIG. 1 is a block diagram of an exemplary system of the present disclosure suitable for use in providing transaction settlement as a service, via a settlement payment network;

FIG. 2 is a block diagram of a computing device that may be used in the exemplary system of FIG. 1; and

FIG. 3 is a flow diagram of an exemplary method, which may be implemented in connection with the system of FIG. 1, for use in providing transaction settlement as a service, via a settlement payment network, for transactions originated through a different payment network.

Corresponding reference numerals indicate corresponding parts throughout the several views of the drawings.

### DETAILED DESCRIPTION

Exemplary embodiments will now be described more fully with reference to the accompanying drawings. The description and specific examples included herein are intended for purposes of illustration only and are not intended to limit the scope of the present disclosure.

Consumers often fund purchase transactions with payment accounts. Upon initiation of the transactions, merchants seek authorization for the transactions, via a payment network, whereby, upon authorization, the merchants are able to continue the transactions. Funds are later delivered to (or allocated from, for refunds) accounts associated with the merchants through clearing and settlement of the transactions, as handled by the payment network through which the authorization was initially received (or directly among of the transacting institutions, transacting parties, and/or affiliates thereof). Uniquely, the systems and methods herein provide settlement of transactions as a service, via a settlement payment network, when the transactions are initiated through an origination payment network (different from the settlement payment network). In particular, a payment transaction may be initiated through the origination payment network, whereby the origination payment network provides messaging between a transacting institution (or transacting party) of the source account and a transacting institution of the destination account (to provide notifications and/or requests for funds, etc.). Once initiated, through messaging associated with the origination payment network, a further message associated with the transaction is provided to a different settlement payment network. In connection therewith, a translation engine associated with the settlement payment network translates the record (and/or message) from its native format (e.g., SWIFT™ standard format at the origination payment network, etc.) to a different standard format (e.g., IPM standard format at the settlement payment network, etc.) and appends the message, once translated, to clearing records associated with the transacting institutions. Later, funds associated with the transaction are transferred, as appropriate, to settle the transaction between the transacting institutions (individually or together with other transactions between the institutions). In this manner, the settlement payment network, by receiving and translating the transaction message, alleviates the transacting institutions (or affiliate banking institutions in appropriate regions) from having to directly settle the transaction with another transacting institution, even when the transaction is originated through another payment network (which is either suited or unsuited to settlement).

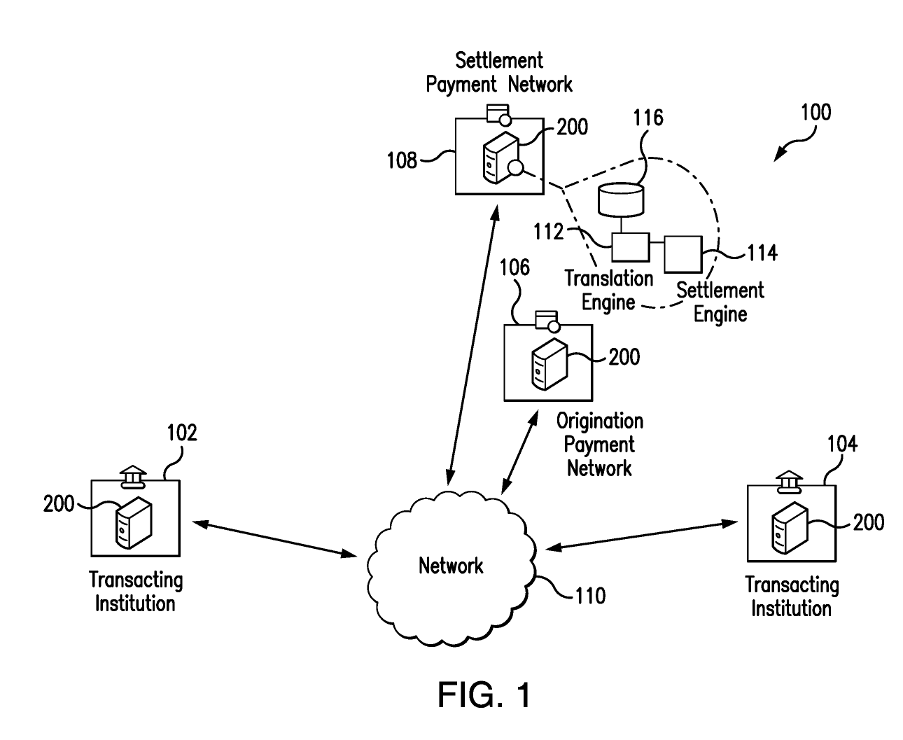

FIG. 1 illustrates an exemplary system 100 in which the one or more aspects of the present disclosure may be implemented. Although the system 100 is presented in one arrangement, other embodiments may include the parts of the system 100 (or other parts) arranged otherwise depending on, for example, authorization, clearing and/or settlement processes employed by the transacting institutions, etc.

As shown in FIG. 1, the illustrated system 100 generally includes two transacting institutions 102 and 104, an origination payment network 106 and a settlement payment network 108, each coupled to (and in communication with) network 110. The network 110 may include, without limitation, a local area network (LAN), a wide area network (WAN) (e.g., the Internet, etc.), a mobile network, a virtual network, and/or another suitable public and/or private network capable of supporting communication among two or more of the parts illustrated in FIG. 1, or any combination thereof. For example, network 110 may include multiple different networks, such as a private payment transaction network made accessible by the origination payment network 106 and the settlement payment network 108 and, separately, the public Internet, which may provide interconnection between the origination payment network 106 and the transacting institutions 102 and 104, etc.

In the exemplary embodiment, each of the transacting institutions 102 and 104 is also referred to herein as a transacting party and may include, without limitation, a bank, a financial institution, an investment institution, a loan provider, a checking account provider, a payment account issuer, a general corporation, a non-bank institution, or another entity that participates in transactions as described herein, etc. In this exemplary embodiment, each of the transacting institutions 102 and 104 provides accounts to account holders (e.g., individuals, entities, corporations, businesses, etc.). The holders fund the accounts with funds, which then may be transferred, at the direction of the holders, to one or more other accounts associated with the transacting institutions 102 and/or 104 or to one or more other accounts associated with other transacting institutions, etc. In addition, the transacting institutions 102 and 104 may be account holders, where their accounts are provided and/or issued by other institutions (e.g., when the transacting institution is a non-bank institution, etc.). In various example embodiments, the transacting institutions 102 and 104 may be each associated with affiliate institutions (not shown), which issue accounts to the transacting institutions 102 and 104, and which permit the transacting institutions 102 and 104 to participate in fund transfers in other regions (e.g., other countries, etc.), for example.

It should be appreciated that the transfer of funds, as described herein, may be coordinated by a variety of mechanisms, directly between the transacting institutions 102 and 104, or in cooperation with other entities, networks, or transacting institutions.

Specifically, in this exemplary embodiment, the origination payment network 106 is configured to provide messaging between the transacting institutions 102 and 104 (or affiliates associated therewith) to facilitate transfers of funds therebetween. The origination payment network 106 includes any network and/or messaging service, which permits the transacting institutions 102 and 104 (and/or other transacting institutions) to originate and/or initiate transactions between different accounts (e.g., domestic transactions, cross-border transactions, etc.).

In this exemplary embodiment, for example, the origination payment network 106 may include a SWIFT™ messaging service provider, which is suited to provide messaging associated with domestic and cross-border transactions between the transacting institutions 102 and 104 (e.g., in SWIFT™ standard format, etc.). Specifically, the SWIFT™ payment network enables transacting institutions worldwide, or in various countries, to send and receive messaging specific to financial transactions in a secure, standardized and reliable environment. The SWIFT™ payment network, however, does not participate in transfer of funds resulting from the messaging. Rather, conventionally, it permits the transacting institutions (or associated affiliates) (e.g., transacting institutions 102 and 104, etc.) to send payment orders, which are then settled directly by the transacting institutions (or associated affiliates) and the corresponding accounts (generally independent of the SWIFT™ payment network, etc.). Each of the transacting institutions 102 and 104, in this exemplary embodiment, has a banking relationship with the other transacting institutions 102 and 104 (or an associated affiliate) (e.g., to enable fund transfers therebetween, etc.).

The origination payment network 106 is configured to rely on a specific standard or format, through which messages (e.g., notifications, requests, etc.) are exchanged between the transacting institutions 102 and 104. Again, the origination payment network 106, in this example, relies on the SWIFT™ message format. The format includes a variety of different message types, which may be employed herein. The particular message type used is generally indicated by code, including three digits where a first digit represents a category, a second digit represents a group of related parts in a transaction cycle, and a third digit indicates the type that denotes the specific message. In one example, an MT103 message is a message type (MT) notification (3) related to a cash transfer (1) to/from a financial institution (0). The specific SWIFT™ standard format supported by the origination payment network 106 is available at www.swift.com/standards/, which is incorporated herein by reference in its entirety.

Other exemplary message types may be used herein, including, without limitation, MT101, MT102, MT102STP, MT103STP, MT103REMIT, MT199 (free format message), MT202COV, MT9XX, and/or other suitable MT message types. Further still, other message formats altogether, such as, for example, the ISO20022 format and/or other suitable message formats, etc., may be employed by the origination payment network 106, as desired.

Beyond the specific message types, consistent with the SWIFT™ standard format in this example, the messages will also include data organized into fields of tags of the messages. For a transfer message from a payor account (issued by transacting institution 102) to a payee account (issued by transacting institution 104) (e.g., a MT103/202COV message, etc.), for example, the data fields (or tags) may include, without limitation, a SWIFT™ code, a sender's transaction reference number, a bank operation code, a value date, a currency code, an amount, an ordering customer (i.e., the payor), an ordering institution (i.e., transacting institution 102), a sending institution, a beneficiary (i.e., the payee), a beneficiary bank (i.e., transacting institution 104), a beneficiary customer account, remittance information, details of the charge, etc. With that said, Table 1 includes the above fields or tags, and others, along with the designated fields or tags of the data in an MT103 message.

TABLE 1

| Field | Field Name |
|---|---|
| :20 | Transaction Reference Number |
| :23B | Bank Operation Code |
| :32A | Value Date/Currency/Interbank Settled |
| :33B | Currency/Original Ordered Amount |
| :50A, F or K | Ordering Customer (Payer) |
| :52A or D | Ordering Institution (Payer's Bank) |
| :53A, B or D | Sender's Correspondent (Bank) |
| :54A, B or D | Receiver's Correspondent (Bank) |
| :56A, C or D | Intermediary (Bank) |
| :57A, B, C or D | Account with Institution (Beneficiary's Bank) |
| :59 or 59A | Beneficiary |
| :70 | Remittance Information |
| :71A | Details of Charges (OUR/SHA/BEN) |
| :72 | Sender to Receiver Information |
| :77A | Regulatory Reporting |

It should be appreciated that the data included in the fields or tags may vary based on the actual data to be included. For example, the fields or tags at 52, 53, 54, 56, 57 each may be populated with a number, such as, for example, a business identifier code (BIC), for the specified institution, and the fields or tags at 50 and 59 each may be populated with an account number or the BIC.

That said, it should further be appreciated that other standards and/or formats of messaging may be employed by the origination payment network 106 in other embodiments. Separately in the system 100, the settlement payment network 108 is configured to provide settlement fund transfers (broadly, transactions) between the transacting institutions 102 and 104. Like the origination payment network 106, the settlement payment network 108 also is configured to rely on a specific standard format for messaging, through which the messages are exchanged with the transacting institutions 102 and 104 in communication therewith. Specifically, in this exemplary embodiment, the settlement payment network 108 may employ the IPM or “integrated product message” standard format, which is a variable-length format that facilitates the addition of new data elements while allowing the message receiver to manage the recognition and use of the new data through use of a bit map representation. The IPM format is based on the ISO 8583-1993 specification. It should be appreciated that in one exemplary embodiment, the settlement payment network 108 may include the Mastercard® payment network, and that the IPM standard format is the standard format utilized by the Mastercard® payment network. For purposes of illustration, Table 2 includes a segment of the message layout for an exemplary IPM first presentment message, and in particular, a 1240 message. That said, the listing is only exemplary and other data elements are typically included in the specific 1240 message and may be used herein. And, like above, despite this specific example, it should be appreciated that other standards and/or formats of messaging may be employed by the settlement payment network 108 in other embodiments.

TABLE 2

| Data Element No. | Data Element Name |
|---|---|
| 2 | Primary Account Number (PAN) |
| 4 | Amount, Transaction |
| 5 | Amount, Reconciliation |
| 32 | Acquiring Institution ID Code |
| 49 | Currency Code, Transaction |
| 50 | Currency Code, Reconciliation |
| | Conversion Rate, Reconciliation |
| 62 | Additional Data 2 |
| 123 | Additional Data 3 |
| 124 | Additional Data 4 |
| 125 | Additional Data 5 |

Again, it should be appreciated that the formats disclosed herein, and included in Table 1 and 2, for example, are merely exemplary and that other formats may be employed in the origination payment network 106 and/or settlement payment network 108 to thereby defined different mapping therebetween. In one embodiment, for example, the settlement payment network 108 may employ a “Send Advice and Detail File” as a manner of communicating the settlement details to a settlement instruction file or SIF (as used by the settlement payment network 108). Despite this additional example, again, other formats may be employed in the relevant payment network in other system embodiments.

While only two transacting institutions 102 and 104, one origination payment network 106 and one settlement payment network 108 are illustrated in FIG. 1, it should be appreciated that any number or types of these entities (and their associated components) may be included in the system 100, or as a part of other system embodiments, consistent with the present disclosure.

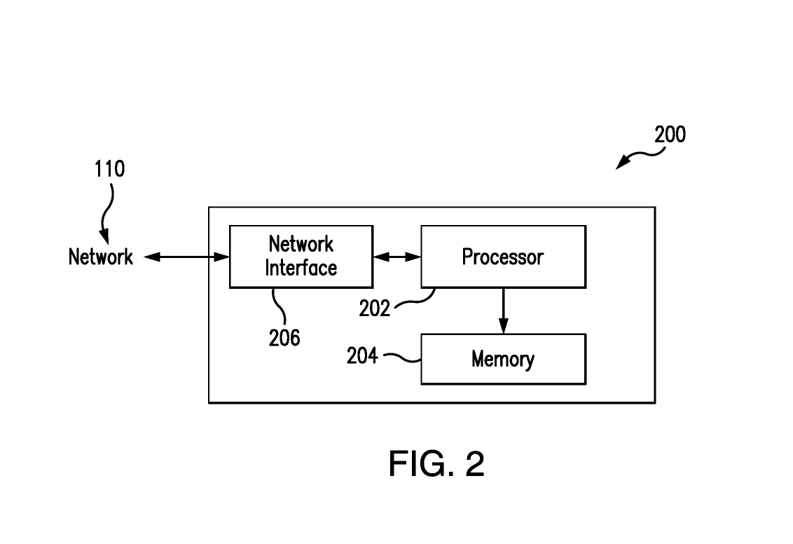

FIG. 2 illustrates an exemplary computing device 200 that can be used in the system 100. The computing device 200 may include, for example, one or more servers, workstations, desktop computers, laptops, tablets, etc. In addition, the computing device 200 may include a single computing device, or it may include multiple computing devices located in close proximity or distributed over a geographic region, so long as the computing devices are specifically configured to function as described herein. In the exemplary embodiment of FIG. 1, each of the transacting institutions 102 and 104, the origination payment network 106 and the settlement payment network 108 are illustrated as including, or being implemented in, computing device 200, coupled to (and in communication with) the network 110. However, the system 100 should not be considered to be limited to the computing device 200, as described below, as different computing devices and/or arrangements of computing devices may be used. In addition, different components and/or arrangements of components may be used in other computing devices.

Referring to FIG. 2, the exemplary computing device 200 includes a processor 202 and a memory 204 coupled to (and in communication with) the processor 202. The processor 202 may include one or more processing units (e.g., in a multi-core configuration, etc.). For example, the processor 202 may include, without limitation, a central processing unit (CPU), a microcontroller, a reduced instruction set computer (RISC) processor, an application specific integrated circuit (ASIC), a programmable logic device (PLD), a gate array, and/or any other circuit or processor capable of the functions described herein.

The memory 204, as described herein, is one or more devices that permit data, instructions, etc., to be stored therein and retrieved therefrom. The memory 204 may include one or more computer-readable storage media, such as, without limitation, dynamic random access memory (DRAM), static random access memory (SRAM), read only memory (ROM), erasable programmable read only memory (EPROM), solid state devices, flash drives, CD-ROMs, thumb drives, floppy disks, tapes, hard disks, and/or any other type of volatile or nonvolatile physical or tangible computer-readable media. The memory 204 may be configured to store, without limitation, messages (and data included therein), amounts, settlement records, message codes, transaction reference numbers, ICAs, bank operation codes, value dates, currency codes, ordering customers (i.e., payors), ordering institutions, beneficiaries (i.e., payees), accounts with the institutions, remittance information, details of charges, and/or other types of data (and/or data structures) suitable for use as described herein. Furthermore, in various embodiments, computer-executable instructions may be stored in the memory 204 for execution by the processor 202 to cause the processor 202 to perform one or more of the functions described herein, such that the memory 204 is a physical, tangible, and non-transitory computer readable storage media. Such instructions often improve the efficiencies and/or performance of the processor 202 and/or other computer system components configured to perform one or more of the various operations herein. It should be appreciated that the memory 204 may include a variety of different memories, each implemented in one or more of the functions or processes described herein.

Further, the illustrated computing device 200 also includes a network interface 206 coupled to (and in communication with) the processor 202 and the memory 204. The network interface 206 may include, without limitation, a wired network adapter, a wireless network adapter, a mobile network adapter, or other device capable of communicating to one or more different networks, including the network 110.

Referring again to FIG. 1, the settlement payment network 108 includes a translation engine 112 and a settlement engine 114, each of which is specifically configured, by computer executable instructions, to perform one or more of the operations described herein. In the illustrated embodiment, the translation engine 112 is provided as a part of the settlement payment network 108, for example. However, it should be appreciated that the translation engine 112 may alternatively be separate, at least partly or entirely, from the settlement payment network 108. Further, it should be appreciated that the translation engine 112 may be associated with, or incorporated with, other parts of the system 100, in other embodiments, etc. Also, in this exemplary embodiment, the translation engine 112 and the settlement engine 114 may each be considered a computing device consistent with computing device 200. Alternatively, one or more of the translation engine 112 and the settlement engine 114 may be included in the computing device 200 of the settlement payment network 108.

The settlement payment network 108 of the system 100 also includes a translation data structure 116, which is coupled to (and is in communication with) the translation engine 112. The translation data structure 116 includes one or more maps, which are specific to the formats employed by the origination payment network 106 and/or the settlement payment network 108 (or other payment networks as appropriate) to allow conversions therebetween. The translation data structure 116 may be a standalone part of the settlement payment network 108, as shown in FIG. 1, or it may be included in memory of the translation engine 112 (e.g., memory 204, etc.) or elsewhere in the system 100.

In this exemplary embodiment, the transacting institutions 102 and 104 are enrolled with the settlement payment network 108, such that when a transaction (e.g., between the transacting institutions 102 and 104, etc.) is authorized via the origination payment network 106, the transaction is settled through the settlement payment network 108.

In particular, for an example transaction including a transfer from a payor account (issued by transacting institution 102) to a payee account (issued by transacting institution 104), the transacting institution 102 (at the direction of the payor) is configured to compile a message consistent with the SWIFT™ format, and in particular, in this example, an MT103 type message. The transacting institution 102 is configured to then transmit the message, via the network 110, to the origination payment network 106. In compiling the message, the transacting institution 102 is configured to access a directory data structure (i.e., a participant directory in memory 204, etc.) and therefrom determine whether the recipient institution, i.e., the transacting institution 104, is enrolled with and/or participating with the settlement payment network 108 (for settlement services). If enrolled or participating, the transacting institution 102 is configured to include a settlement service flag within one of the tags/fields of the MT103 message, which may include, for example, the tag/field 53A (Sender's Correspondent) of the MT103 message, prior to transmitting the message to the origination payment network 106. If not enrolled or participating, the transacting institution 102 is configured to not include the settlement service flag, whereby the transaction will proceed as conventional.

As indicated above, with reference to the different types of SWIFT™ format messages, it should be understood that other messages may be provided between the transacting institutions 102 and 104 to notify and/or request fund transfers (broadly, all messages). Regardless of the particular standard format, though, the translation engine 112 is configured to append the settlement service flag, as appropriate, and at the appropriate location (or data element) within the message.

Upon receipt of the message, the origination payment network 106 is configured to pass the message along to the transacting institution 104. The transacting institution 104, in turn, may be configured to respond to the message with an acknowledgement (broadly, a message) (again consistent with the SWIFT™ standard format, etc.). The acknowledgement is then provided, by the origination payment network 106, back to the transacting institution 102. Subsequently, or in connection therewith, the origination payment network 106 is further configured to detect the settlement service flag in the message (if present) and to transmit the message to the settlement payment network 108. It should be appreciated that the origination payment network 106 may further transmit one or more messages associated with the transaction to one or more affiliate institutions (not shown), as needed or desired to sufficiently direct the fund transfer.

In turn, the settlement payment network 108, and in particular, the translation engine 112, is configured to receive the message and to translate the message from its original format (e.g., the SWIFT™ standard format, etc.) to the standard format of the settlement payment network 108 (e.g., the IPM standard format). Specifically, the translation engine 112 is configured to retrieve a map from the translation data structure 116. An exemplary map, stored in translation data structure 116, is provided below in Table 3. As shown, the map provides conversion from multiple fields or tags in the SWIFT™ message format to the data elements in the IPM message format.

TABLE 3

| SWIFT ™ | | IPM | |
|---|---|---|---|
| MT103/202 | | 1240 Presentment Message | |
| Field | Definition | Data Element | Definition |
| 20 | transaction reference | 123 | Additional Data 3 |
| | number | | |
| 32A | Order description | 50 | Currency Code, |
| | Sub-field 1: | | Reconciliation |
| | Preferred execution | | |
| | date | | |
| | Sub-field 2: | 5 | Amount, |
| | Currency | | Reconciliation |
| | Sub-field 3: | | |
| | Amount | | |
| 33B | Currency/Instructed | 49 | Currency Code, |
| | Amount | | Transaction |
| | | 4 | Amount, Transaction |
| 50a | ordering customer | 125 | Additional Data 5 |
| 51A | sending institution | 32 | Acquiring Institution |
| | | | ID Code |
| 57A | Beneficiary Bank | 2 | Primary Account |
| | | | Number (PAN) (Incl |
| | | | ICA = SWIFT code) |
| 59A | beneficiary customer | 62 | Additional Data 2 |
| | account | | |
| 70 | remittance | 124 | Additional Data 4 |
| | information | | |

Once retrieved, the translation engine 112 is configured to convert the SWIFT™ format message to an IPM format message based on the retrieved map, whereby the data of the field (or tag) in the SWIFT™ format message is included in specified data element(s) of the IPM format message. In particular, the IPM format message is a first presentment 1240 message consistent with the IPM format standard in this embodiment (based on the SWIFT™ message). That said, other messages defined by the IPM format standard format, or by other standard formats, may be provided/converted by the translation engine 112 based on one or more other maps included in the translation data structure 116 in other embodiments, etc.

Subsequently in the system 100, the translation engine 112 is configured to route the IPM format message to the settlement engine 114 of the origination payment network 106 (i.e., the computing device 200 or otherwise) (e.g., Mastercard® Global Clearing Management System (GCMS) and/or Mastercard® Settlement Account Manager (SAM), etc.). In response, the settlement engine 114 is configured to transmit an acknowledgement to the translation engine 112, which, in turn, transmits the acknowledgement as a message consistent with the SWIFT™ format (e.g., ACK (acknowledgment)/NAK (negative acknowledgment), etc.) to the origination payment network 106. At more defined settlement intervals, the settlement engine 114 is configured to then settle the transactions provided thereto for a settlement interval (e.g., hourly, daily, and/or as defined by specified times, or other intervals, etc.).

Thereafter, the settlement engine 114 is configured to, for example, generate a fund transfer order (to the transacting institution 102), generate a settlement advisement (to the transacting institution 104), and generate a member advisement (to the transacting institution 104). The settlement engine 114 is configured to settle the transfer between the account associated with the transacting institution 102 and the account for the transacting institution 104 (e.g., via the SAM, etc.), based on the transfer order and the settlement advisement. Further, the settlement engine 114 is configured to transmit the member advisement, via the origination payment network 106 and the translation engine 112, to the transacting institution 104 (e.g., as a SWIFT™ message, etc.). In one or more embodiments, a notification may be further transmitted to the transacting institution 102, by the settlement engine 114 (via the translation engine 112 and the origination payment network 106) and/or the translation engine 112 (via the origination payment network 106) (e.g., a MT940 notification, etc.). It should be appreciated that the settlement engine 114 may be configured to provide other messages and/or notifications (e.g., orders, advisements, etc.) to the transacting institutions 102 and 104 directly, via the settlement payment network 108, or indirectly, via the translation engine 112 and the origination payment network 106.

In this exemplary embodiment, the message may be provided to the translation engine 112 and/or the settlement engine 114, for example, via a Mastercard® Interface Processor (MIP), Complex to Complex (CTC), Mastercard® File Express (MFE), or other suitable interface associated with the origination payment network 106 and/or the translation engine 112, as appropriate, etc.

It should be appreciated, that while described with reference to one transaction and a fund transfer from the transacting institution 102 to the transacting institution 104, other transactions (in the same or opposite directions, or with other transacting institutions) will likely be included in the settlement of fund transfers and accommodated by the system 100 described herein.

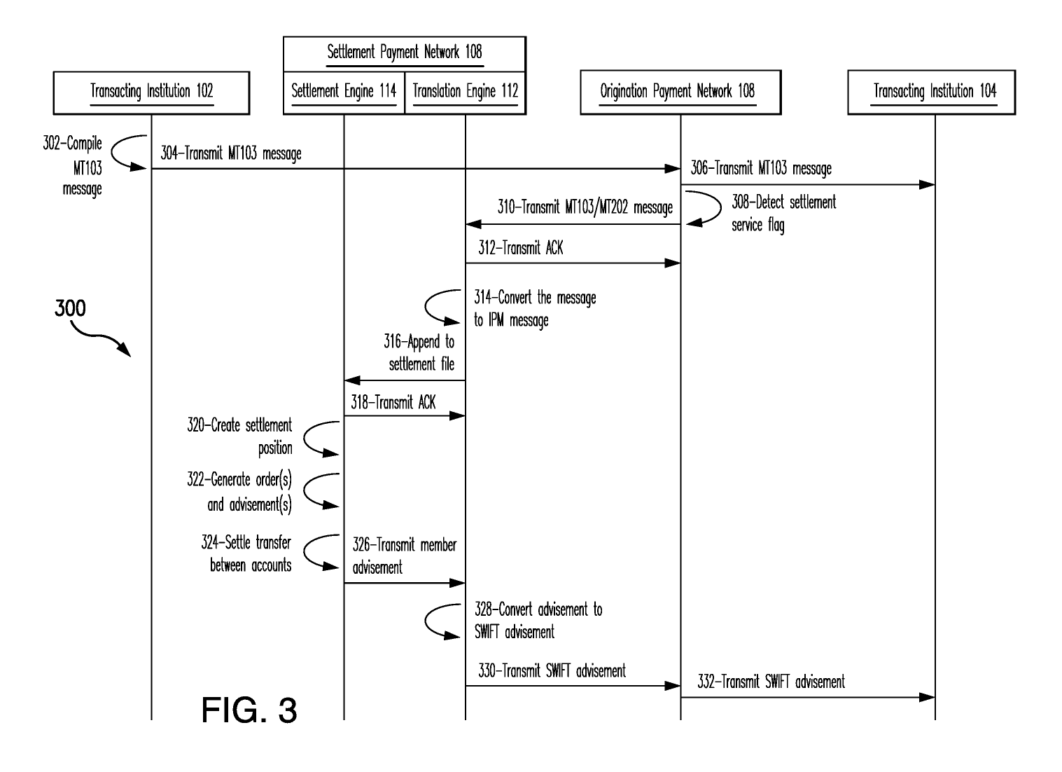

FIG. 3 illustrates an exemplary method 300 for providing network settlement as a service via a settlement payment network for transactions originated apart from the settlement payment network 108. The exemplary method 300 is described as implemented in the transacting institutions 102 and 104, and the origination payment network 106, and also in the translation engine 112, and the settlement engine 114 of the settlement payment network 108, all of which are included in the system 100, and with still further reference to the computing device 200. However, the methods herein should not be understood to be limited to the system 100 or the computing device 200, as the methods may be implemented in other systems and/or computing devices. Moreover, the systems and the computing devices herein should not be understood to be limited to the exemplary method 300.

For purposes of illustration, the method 300 is described with reference to an exemplary transaction between a payor account at the transacting institution 102 and a payee account at the transacting institution 104, provided via an MT103 type message. However, it should again be appreciated that the description herein should not be understood to be limited to this single exemplary transaction, or to a particular type of messaging, or to the limited participation of the transacting institutions 102 and 104. For example, the transacting institutions 102 and 104 may each participate in multiple transactions with one another and/or third, fourth, etc., transacting institutions, whereby the settlement position created herein may be affected by those other transactions. In addition, the multiple transactions between and/or involving the transacting institutions 102 and 104 may be pursuant to different message types and/or standard formats, as described herein.

Initially in the method 300, the transacting institution 102 identifies a fund transfer from an account issued by the transacting institution 102 to an account issued by the transacting institution 104. The fund transfer may be, for example, requested by a consumer associated with the payor account at the transacting institution 102 (e.g., as payment for a debt, etc.) to a consumer associated with the payee account issued by the transacting institution 104. Or, the fund transfer may be associated with a business agreement between the transacting institutions 102 and 104, etc. In any case, upon identifying the fund transfer to be made (and the type of message to be transmitted), the transacting institution 102 compiles a message (e.g., a request, etc.) consistent with the SWIFT™ standard format. In particular in this example, the transacting institution 102 compiles, at 302, an MT103 message, which is the type of message associated with a notification of a fund transfer to the transacting institution 104. The message will further include data in one or more fields (or tags), which define the transaction, including, without limitation, a transfer reference number at field 20, a value date, a currency code, an amount at field 32A, an ordering customer at field 50a, a sending institution (i.e., the transacting institution 102) at field 51A, a beneficiary bank at field 57A, a beneficiary customer account (payee) at field 59A, and remittance information at field 70, etc. In addition, as part of compiling the message, as indicated above, the transacting institution 102 accesses and searches for the transacting institution 104 in a directory of transacting institutions in a data structure (e.g., stored in memory 204, etc.), including a listing of the transacting institutions enrolled with the settlement payment network 108 (i.e., for network settlement as a services). If found in the data structure, the transacting institution 102 appends a settlement service flag to the message as an indication of settlement with the settlement payment network 108 (e.g., at field 53A, etc.).

After compiling the message, the transacting institution 102 transmits the MT103 message to the origination payment network 106, at 304. In turn, the origination payment network 106 transmits the MT103 message on to the transacting institution 104, at 306. Although not shown, it should be appreciated that the transacting institution 104 may or may not transmit an acknowledgement (e.g., confirmation, etc.) (e.g., a MT199 message, etc.) to the origination payment network 106 and/or the transacting institution 102 (e.g., via the origination payment network 106), in response to the MT103 message. Similarly, the origination payment network 106 may or may not provide an acknowledgement to the transacting institution 102 (e.g., upon receipt of the MT103 message, or recipient of the acknowledgement from the transacting institution 104, etc.). Regardless, at 308, the origination payment network 106 determines whether the MT103 message includes the settlement service flag therein. If included, the transaction is to be settled by the settlement payment network 108, and as such, the origination payment network 106 transmits, at 310, the authorization to the settlement payment network 108, and in particular, to the translation engine 112. At 314, in turn, the translation engine 112 responds by transmitting, at 312, an acknowledgement (ACK) to the origination payment network 106.

Alternatively, the originating payment network 106 may submit the transaction for settlement to the settlement payment network 108 based on a different and/or subsequent message. Specifically, for example, in one or more embodiments, when a MT103 message is provided in connection with a transaction, the transacting institution 102 will also transmit a MT202 (e.g., including the same or similar data to the MT103 message above, etc.) for purpose of settlement. In such embodiments, the origination payment network 106 may not transmit the MT103 message to the settlement payment network 108, but, instead, wait on the MT202 message. Upon receipt, the transacting institution 102 then transmits, at 310, the MT202 message to the settlement payment network 108 for purposes of settlement (but, generally, it is not transmitted, or is only optionally transmitted, to the transacting institution 104, etc.)

Subsequently, regardless of the type of message received by the settlement payment network 108, the translation engine 112 converts the message to an IPM message, at 314. The IPM message may include, for example, a first presentment 1240 message, or other message consistent with the IPM standard format (or other format (standard or otherwise) as employed by and/or known to the settlement payment network 108). Specifically, as described above, the settlement payment network 108 includes the translation data structure 116, which includes one or more maps for converting one standard format to a different standard format. Here, the translation engine 112 retrieves the map associated with the SWIFT™ standard format and converts, at 314, the MT103 (or MT202) message (as part of the SWIFT™ standard format) to an IPM standard format message. The IPM standard format message then includes the data included in the fields or tags of the SWIFT™ standard format message, in the respective data elements of the IPM message, as defined by the retrieved map.

Again, it should be appreciated that the method 300 is not limited to the specific IPM standard as described herein, as other formats may be employed by the settlement payment network 108 to define messaging related to payment account transactions. For example, the settlement payment network 108 may employ a different format, whereby the SWIFT® message are converted (e.g., by use of one or more appropriate maps, etc.) to a “Send Advice and Detail File” which corresponds to the settlement information file (SIF) in the settlement payment network 108.

Once converted, the translation engine 112 then provides the IPM message to the settlement engine 114. In this exemplary embodiment, the translation engine 112 appends, at 316, the IPM message to a settlement file (e.g., a R111 file, etc.) included in and/or associated with the settlement engine 114. Depending on the particular arrangement of the translation engine 112 and/or the settlement engine 114, the translation engine 112 may, optionally, transmit the IPM message to the settlement engine 114 (e.g., at 316, etc.). In any case, when the IPM message is received and understood at the settlement engine 114, the settlement engine 114 in response transmits, at 318, an acknowledgement (ACK) to the translation engine 112.

The settlement engine 114 then (e.g., at one or more settlement intervals, etc.) creates a settlement position for the transacting institutions 102 and 104, at 320. Here, the settlement position will reflect at least the one transfer. That said, in general, multiple transactions (e.g., hundred, thousands, tens of thousands, etc.) may be included in a settlement period and may involve the transacting institutions 102 and 104, in either direction. The transactions may further take into account transactions that were authorized through the settlement payment network 108, or by other payment networks, etc. In connection therewith, the settlement positon reduces all of the transactions to one transfer to/from the transacting institutions 102 and 104. The creation of the settlement positon, then, may be referred to as, or as part of, clearing.

Subsequently in the method 300, the settlement engine 114 generates, at 322, a fund transfer order (e.g., an order for funds to be transferred from the transacting institution 102 to the transacting institution 104, etc.), a settlement advisement and a member advisement, etc. In this exemplary embodiment, the settlement engine 114 then settles the transfer, at 324, based on the fund transfer order and the settlement advisement. The settlement may occur directly with the accounts associated with the transacting institutions 102 and 104, or with accounts of affiliates associated with the transacting institutions 102 and 104 (e.g., for cross-border transactions, etc.). In addition, the settlement engine 114 transmits, at 326, the member advisement on to the translation engine 112. Upon receipt, the translation engine 112 converts the member advisement into a message in the SWIFT™ standard format, i.e., a SWIFT™ member advisement, at 328, and then transmits the SWIFT™ member advisement to the origination payment network 106, at 330. In turn, the origination payment network 106 transmits the SWIFT™ member advisement to the transacting institution 104, at 332.

While the above transaction is provided as being initiated at the transacting institution 102, other transactions may be originated at other institutions (e.g., at the transacting institution 104, etc.) and settled substantially consistent with method 300. For example, rather than a push transaction from the transacting institution 102, the transaction may include a pull transaction or a request for reimbursement from the transacting institution 104. In general, though, the transactions will still occur in the same manner as described above in connection with the origination payment network 106 and/or the settlement payment network 108.

In view of the above, the systems and methods herein permit settlement to be accomplished efficiently, through a payment network, when the transactions associated with the settlement are authorized and/or coordinated through a different payment network. In this manner, for example, in the system 100, the origination payment network 106 may be able to reach the objective of near real-time payments and/or further provide a solution for settlement issues (e.g., lack of integrated settlement features, etc.) associated with utilizing the origination payment network 106, regardless of the value of the transactions. Similarly, the transacting institutions may be able to reduce costs associated with sending cross-border transfers and reduce and/or eliminate individual relationships with multiple other transacting institutions (e.g., correspondent relationship with banks in multiple regions to support cross-border transaction, etc.) (e.g., institutions of low value and/or volume transfers, etc.), which may cause transactions to the opaque slow and expensive, while still being able to disburse to multiple end-point institutions through the associated settlement payment network, etc. Moreover, the transacting institutions may be able to extend settlement assurances associated with the settlement payment network, enable faster receipt of funds (as compared to conventional SWIFT™ settlement directly among the institutions), and/or predict delivery time and amount of funds, etc.

Again, and as previously described, it should be appreciated that the functions described herein, in some embodiments, may be described in computer executable instructions stored on a computer-readable media, and executable by one or more processors. The computer readable media is a non-transitory computer-readable storage medium. By way of example, and not limitation, such computer-readable media can include RAM, ROM, EEPROM, CD-ROM or other optical disk storage, magnetic disk storage or other magnetic storage devices, or any other medium that can be used to carry or store desired program codes in the form of instructions or data structures and that can be accessed by a computer. Combinations of the above should also be included within the scope of computer-readable media.

It should also be appreciated that one or more aspects of the present disclosure transform a general-purpose computing device into a special-purpose computing device when configured to perform the functions, methods, and/or processes described herein.

As will be appreciated, based on the foregoing specification, the above-described embodiments of the disclosure may be implemented using computer programming or engineering techniques, including computer software, firmware, hardware or any combination or subset thereof, wherein, the technical effect may be achieved by performing at least one of the following operations: (a) receiving, at a settlement payment network, a first message from an origination payment network, the first message defining a transaction between a first transacting institution and a second transacting institution, the first message being in a first standard format and including data in multiple data fields, the first standard format associated with the origination payment network; (b) converting, by the settlement payment network, the message from the first standard format to a second message in a second standard format different than the first standard format, whereby the second message includes at least a portion of the data included in the message; (c) directing, by the settlement payment network, settlement of the transaction based on the second message, whereby the origination payment network provides settlement through the settlement payment network; (d) retrieving a map, from a data structure, associated with the first standard format; (e) converting the first message to the second message based on the retrieved map; (f) receiving, by the origination payment network, the first message from the first transacting institution; (g) transmitting, by the origination payment network, the first message to the settlement payment network when the first message includes a settlement service flag; (h) appending, by the first transacting institution, the settlement service flag to the first message, prior to transmitting the first message to the origination payment network; (i) creating a settlement position for at least the first and second transacting institutions, the settlement position representative of at least the transaction; (j) generating a fund transfer order for one of the first and second transacting institutions; (k) settling the fund transfer among accounts associated with the first and second transacting institution; (l) generating and transmitting a member advisement, for the other of the first and second transacting institutions, to the origination payment network; (m) converting the member advisement to the first standard format, prior to transmitting the member advisement to the origination payment network; and (n) settling the transaction between accounts associated with the first and second transacting institutions, which are accessible to the settlement payment network, the account associated with the first transacting institution is an account issued by an affiliate of the first transacting institution.

Exemplary embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular exemplary embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When a feature is referred to as being “on,” “engaged to,” “connected to,” “coupled to,” “associated with,” “included with,” or “in communication with” another feature, it may be directly on, engaged, connected, coupled, associated, included, or in communication to or with the other feature, or intervening features may be present. As used herein, the term “and/or” includes any and all combinations of one or more of the associated listed items.

In addition, as used herein, the term product may include a good and/or a service.

Although the terms first, second, third, etc. may be used herein to describe various features, these features should not be limited by these terms. These terms may be only used to distinguish one feature from another. Terms such as “first,” “second,” and other numerical terms when used herein do not imply a sequence or order unless clearly indicated by the context. Thus, a first feature discussed herein could be termed a second feature without departing from the teachings of the example embodiments.

None of the elements recited in the claims are intended to be a means-plus-function element within the meaning of 35 U.S.C. § 112(f) unless an element is expressly recited using the phrase “means for,” or in the case of a method claim using the phrases “operation for” or “step for.”

The foregoing description of exemplary embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A system for use in facilitating network settlement as a service, for an origination computing device, the system comprising:
a settlement computing device coupled in communication with the origination computing device, the settlement computing device configured to:
receive a first message from the origination computing device, the first message defining a network transaction between a first party and a second party, the first message being in a first standard format and including data in multiple data fields, the first standard format associated with the origination computing device;
convert the message from the first standard format to a second message in a second standard format different than the first standard format, whereby the second message includes at least a portion of the data included in the message; and
direct settlement of the network transaction based on the second message, whereby the origination computing device provides settlement through the settlement computing device.

2. The system of claim 1, wherein the settlement computing device includes a settlement payment network computing device;
wherein the origination computing device includes an origination payment network computing device;
wherein the first party includes a first transacting institution and the second party includes a second transacting institution; and
wherein the first standard format includes a SWIFT™ standard format.

3. The system of claim 2, wherein the second standard format includes an IPM standard format; and
wherein the first message includes one of a MT103 message and a MT202 message.

4. The system of claim 3, wherein, in order to direct settlement of the network transaction, the settlement payment network computing device is configured to:
create a settlement position for at least the first and second transacting institutions, the settlement position representative of at least the transaction;
generate a fund transfer order for one of the first and second transacting institutions;
settle the fund transfer among accounts associated with the first and second transacting institutions; and
generate and transmit a member advisement, for the other of the first and second transacting institutions, to the origination payment network computing device.

5. The system of claim 3, wherein, in order to convert the message, the settlement payment network computing device is configured to:
retrieve a map from a data structure included in the settlement payment network computing device, the map associated with the first standard format; and
convert the first message to the second message based on the retrieved map.

6. The system of claim 2, wherein the data in the multiple fields of the first message includes multiple of a transaction reference number, a bank operation code, a value date, a currency code, an ordering customer, an ordering institution, a beneficiary, and a settlement services tag.

7. The system of claim 2, wherein the settlement payment network computing device comprises a translation engine computing device and a settlement engine computing device;
wherein the translation engine computing device is configured to convert the message from the first standard format to a second message in a second standard format different than the first standard format, whereby the second message includes at least a portion of the data included in the message; and
wherein the settlement engine computing device is configured to:
create a settlement position for at least the first and second transacting institutions, the settlement position representative of at least the transaction;
generate a fund transfer order for one of the first and second transacting institutions;
settle the fund transfer among accounts associated with the first and second transacting institutions; and
generate and transmit a member advisement, for the other of the first and second transacting institutions, to the origination payment network computing device, to thereby direct settlement of the network transaction.

8. The system of claim 2, further comprising the origination payment network computing device, the origination payment network computing device configured to:
receive the first message from the first transacting institution;
append a settlement service flag to the first message, prior to transmitting the first message to the settlement network computing device; and
transmit the first message to the settlement payment network when the first message includes the settlement service flag.

9. A computer-implemented method for use in facilitating transaction settlement as a service for an origination payment network, the method comprising:
receiving, at a settlement payment network, a first message from an origination payment network, the first message defining a transaction between a first transacting institution and a second transacting institution, the first message being in a first standard format and including data in multiple data fields, the first standard format associated with the origination payment network;
converting, by the settlement payment network, the message from the first standard format to a second message in a second standard format different than the first standard format, whereby the second message includes at least a portion of the data included in the message; and
directing, by the settlement payment network, settlement of the transaction based on the second message, whereby the origination payment network provides settlement through the settlement payment network.

10. The computer-implemented method of claim 9, wherein the first standard format includes a SWIFT™ standard format; and
wherein the second standard format includes an IPM standard format.

11. The computer-implemented method of claim 9, wherein converting the first message to a second message includes:
retrieving a map, from a data structure, associated with the first standard format; and
converting the first message to the second message based on the retrieved map.

12. The computer-implemented method of claim 9, further comprising:
receiving, by the origination payment network, the first message from the first transacting institution; and
transmitting, by the origination payment network, the first message to the settlement payment network when the first message includes a settlement service flag.

13. The computer-implemented method of claim 12, further comprising appending, by the first transacting institution, the settlement service flag to the first message, prior to transmitting the first message to the origination payment network.

14. The computer-implemented method of claim 9, wherein directing settlement of the transaction includes:
creating a settlement position for at least the first and second transacting institutions, the settlement position representative of at least the transaction;
generating a fund transfer order for one of the first and second transacting institutions; and
settling the fund transfer among accounts associated with the first and second transacting institutions.

15. The computer-implemented method of claim 14, wherein directing settlement of the transaction further includes generating and transmitting a member advisement, for the other of the first and second transacting institutions, to the origination payment network.

16. The computer-implemented method of claim 15, wherein directing settlement of the transaction further includes converting the member advisement to the first standard format, prior to transmitting the member advisement to the origination payment network.

17. The computer-implemented method of claim 15, wherein directing settlement of the transaction further includes settling the transaction between accounts associated with the first and second transacting institutions and accessible to the settlement payment network; and
wherein the account associated with the first transacting institution is an account issued by an affiliate of the first transacting institution.

18. The computer-implemented method of claim 9, wherein the data in the multiple fields of the first message includes one or more of a transaction reference number, a bank operation code, a value date, a currency code, an ordering customer, an ordering institution, a beneficiary, an account with the first transacting institution, remittance information, and a settlement services tag.

19. The computer-implemented method of claim 9, wherein the second message includes a settlement message; and
wherein data included in multiple data elements of the second message includes one or more of a customer ID, a primary account number (PAN), a transaction amount, a reconciliation amount, a reconciliation conversion rate, an acquiring institution ID code, and a forwarding institution ID code.

20. A non-transitory computer-readable storage media including computer-executable instructions for facilitating transaction settlement as a service, for an origination payment network, which, when executed by at least one processor of a settlement payment network, cause the at least one processor to:
receive a first message from the origination payment network, the first message defining a transaction between a first transacting institution and a second transacting institution, the first message being in a first standard format and including data having multiple of a bank operation code, a value date, a currency code, an ordering customer, and an ordering institution, the first standard format associated with the origination payment network;
convert the message from the first standard format to a second message in a second standard format different than the first standard format, whereby the second message includes the data included in the message;
create a settlement position based on the second message for at least the first and second transacting institutions, the settlement position representative of at least the transaction;
generate a fund transfer order for the first transacting institution;
settle the fund transfer among accounts associated with the first and second transacting institutions; and
generate and transmit a member advisement to the second transacting institution, whereby the origination payment network provides settlement through the settlement payment network.
